(19) United States
(12) Patent Application Publication
(10) Pub. No.: US 2023/0103603 A1
(43) Pub. Date: Apr. 6, 2023

(54) METHODS OF MITIGATING CATALYST DEACTIVATION

(71) Applicant: Battelle Energy Alliance, LLC, Idaho Falls, ID (US)

(72) Inventors: Rebecca R. Fushimi, Idaho Falls, ID (US); Zongtang Fang, Idaho Falls, ID (US); Grigoriy Yablonsky, St. Louis, MO (US)

(21) Appl. No.: 18/061,235

(22) Filed: Dec. 2, 2022

Related U.S. Application Data
(62) Division of application No. 17/013,219, filed on Sep. 4, 2020.
(60) Provisional application No. 62/895,592, filed on Sep. 4, 2019.

(51) Int. Cl. B01J 27/22; B01J 23/652; B01J 38/04; B01J 35/02; B01J 27/28; B01J 37/02

(52) U.S. Cl. CPC B01J 27/22; B01J 23/6525; B01J 27/28; B01J 35/023; B01J 37/0221; B01J 38/04

(57) ABSTRACT

A catalyst structure is disclosed. The catalyst structure comprises a catalytic material and a metal material on the catalytic material, where the metal material comprises particle sizes in a range from about 1.5 nanometers to about 3 nanometers. An interface between the metal material and the catalytic material comprises bonds between the metal material and the catalytic material. A method of mitigating catalyst deactivation is also disclosed, as is a method of carbon monoxide disproportionation.

### CROSS-REFERENCE TO RELATED APPLICATIONS

This application is a divisional of U.S. Pat. Application Serial No. 17/013,219, filed Sep. 4, 2020, which claims the benefit of U.S. Provisional Pat. Application Serial No. 62/895,592, filed Sep. 4, 2019, the disclosure of each of which is hereby incorporated herein in its entirety by this reference.

### STATEMENT REGARDING FEDERALLY SPONSORED RESEARCH OR DEVELOPMENT

This invention was made with government support under Contract Number DE-AC07-05ID14517 awarded by the United States Department of Energy. The government has certain rights in the invention.

### TECHNICAL FIELD

The disclosure relates generally to catalysts, as well as to methods of using those catalysts to mitigate catalyst deactivation. More specifically, the disclosure relates to catalyst deactivation mitigation through site-specific carbon collection.

### BACKGROUND

Many reactions involving carbon-based feedstocks (e.g., shale gas, biomass, syngas, etc.) are based on catalytic processes. For example, heterogeneous chemical conversions, such as the conversion of syngas (CO + H₂) to hydrocarbons, methanol to olefins, methane to ethylene, methane to benzene, propane to propylene and propane to acrylic acid, involve the use of catalysts. These conversions and associated side reactions may include adsorption and reaction processes of carbon containing molecules such as hydrocarbons (e.g., methane, ethane, ethylene, propane, propylene, etc.) or carbon oxides such as carbon monoxide (CO) on transition-metal surfaces, which are used in catalytic processes such as methane activation, selective oxidation or total oxidation, hydrocarbon dehydrogenation, CO disproportionation, CO oxidation, CO methanation, Fischer-Tropsch synthesis, and the water-gas shift reaction.

In the heterogeneous conversion process, the reaction occurs on the catalyst surface. This process is generally associated with one or more active sites on a catalyst (e.g., a metal or metal oxide configuration). Transition metal carbides, such as molybdenum carbide (Mo₂C), have been used in CO₂ reduction, CO₂ hydrogenation, and the water-gas shift reaction, and have shown excellent catalytic properties. Other transition metals involving oxide-supported platinum (Pt) catalysts (e.g., Pt/CeO₂ and Pt/TiO₂) have also shown excellent catalytic properties in these reactions.

In the conversion process, carbonaceous species may be produced as a byproduct. These carbonaceous species often remain bound to the surface of the catalyst, which may change the chemical nature of the active site or physically block access to the site, causing catalyst deactivation. More particularly, the deposition of carbon on the catalytic surface can lead to diminished reaction rates and a diminished catalytic performance.

Some attempted solutions to solve catalyst deactivation have tried to improve the selectivity of the overall reaction to prevent the accumulation of undesired chemical species (such as carbon) on the surface of the catalyst. However, this has failed to meet the needs of the industry because highly selective catalysts often fail to exhibit sufficient activity. In other words, the catalyst may cause certain chemical reactions to preferentially occur, but the catalyst may not perform well after a period of time and may quickly deactivate if undesired chemical species accumulate on the surface. Other attempted solutions have tried implementing procedures that remove the carbonaceous deposits from the surface of the catalyst through processes such as oxidation. However, these solutions are energy intensive and may lead to irreversible damage of the catalyst.

### BRIEF SUMMARY

Embodiments of the disclosure disclosed and taught herein are directed to catalyst structures including a catalytic material and a metal material formulated to mitigate catalyst deactivation, as well as to methods of using those catalyst structures to mitigate catalyst deactivation.

A catalyst structure is disclosed. The catalyst structure includes a catalytic material and a metal material on the catalytic material. The metal material comprises particle sizes in a range from about 1.5 nanometers to about 3 nanometers. An interface between the metal material and the catalytic material comprises bonds between the metal material and the catalytic material.

Also disclosed is a method of mitigating catalyst deactivation. The method includes providing a catalyst structure in a reactor chamber, the catalyst structure comprising a catalytic material and a metal material where the metal material comprises particle sizes in a range from about 1.5 nanometers to about 3 nanometers, and flowing at least one gas into the reactor chamber. The method further includes reacting the at least one gas with the catalyst structure to produce at least one product, as well as at least one undesired chemical species. The method also includes accumulating the at least one undesired chemical species on the metal material without accumulating the at least one undesired chemical species on the catalytic material.

Also disclosed is a method of carbon monoxide disproportionation. The method includes forming a catalyst structure comprising a catalytic material and a metal material where the metal material comprises particle sizes in a range from about 1.5 nanometers to about 3 nanometers, introducing carbon monoxide into a reactor chamber including the catalyst structure, and reacting the carbon monoxide with the catalyst structure to produce carbon dioxide and solid carbon. The method further includes collecting the solid carbon on the metal material of the catalyst structure while active sites of the catalytic material remain available to adsorb the carbon monoxide.

### BRIEF DESCRIPTION OF THE DRAWINGS

FIG. 1 is a schematic illustrating the fabrication of a catalyst in accordance with embodiments of the disclosure;

FIG. 2 is a schematic illustrating the operation of a catalyst formulated to mitigate catalyst deactivation;

FIG. 3 is a schematic diagram illustrating a method of mitigating catalyst deactivation in accordance with embodiments of the disclosure;

FIG. 4 is a flow chart illustrating a method of mitigating catalyst deactivation in accordance with embodiments of the disclosure;

FIG. 5 is a flow chart illustrating a method of CO disproportionation in accordance with embodiments of the disclosure;

FIGS. 6A-6F are graphs illustrating the results of temporal analysis of products (TAP) experiments with the continuous pulsing of CO on clean surfaces of catalysts formed in accordance with embodiments of the disclosure; and

FIGS. 7A and 7B are transmission electron microscopy (TEM) images of catalysts in accordance with embodiments of the disclosure, with FIG. 7B being an enlargement of the boxed portion of FIG. 7A.

### DETAILED DESCRIPTION

A catalyst structure including a catalytic material (e.g., a main catalytic material, a primary catalytic material) and a metal material (e.g., a carbon collecting component, a mitigation component) is disclosed, as are methods of using the resulting catalysts to mitigate catalyst deactivation. These methods may include mitigating catalyst deactivation through site-specific carbon (C) collection. By mitigating catalyst deactivation, the catalyst structure according to embodiments of the disclosure and methods of using the catalyst structure may result in improved catalytic conversion processes having longer lifetimes.

The following description provides specific details, such as material compositions and processing conditions (e.g., temperatures, pressures, flow rates, etc.) in order to provide a thorough description of embodiments of the disclosure. However, a person of ordinary skill in the art will understand that the embodiments of the disclosure may be practiced without necessarily employing these specific details. Indeed, the embodiments of the disclosure may be practiced in conjunction with conventional systems and methods employed in the industry. In addition, only those process components and acts necessary to understand the embodiments of the disclosure are described in detail below. A person of ordinary skill in the art will understand that some process components (e.g., pipelines, valves, temperature detectors, flow detectors, pressure detectors, and the like) are inherently disclosed herein and that adding various conventional process components and acts would be in accord with the disclosure.

As used herein, spatially relative terms, such as “beneath,” “below,” “lower,” “bottom,” “above,” “upper,” “top,” “front,” “rear,” “left,” “right,” and the like, may be used for ease of description to describe one element’s or feature’s relationship to another element(s) or feature(s) as illustrated in the figure. Unless otherwise specified, the spatially relative terms are intended to encompass different orientations of the materials in addition to the orientation depicted in the figure. For example, if materials in the figure are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, “and/or” includes any and all combinations of one or more of the associated listed items.

As used herein, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

As used herein, the term “substantially all” means and includes greater than about 95%, such as greater than about 99%.

As used herein, the term “about” in reference to a numerical value for a particular parameter is inclusive of the numerical value and a degree of variance from the numerical value that one of ordinary skill in the art would understand is within acceptable tolerances for the particular parameter. For example, “about” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof.

As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be excluded.

As used herein, the term “catalyst deactivation” and its grammatical equivalents means and includes a process where reactants or by-products in a chemical conversion process are absorbed or adsorbed (e.g., chemisorbed) on active sites of a catalyst, reducing the number of active sites available for the reaction of interest (e.g., the chemical conversion process). The term “catalyst deactivation” and its grammatical equivalents may also mean and include a process where reactants or by-products in a chemical conversion process are associated with the active sites of a catalyst, changing their chemical nature (e.g., poisoning the active sites) such that the reaction mechanism or the rate constants of the reaction mechanism are changed.

As used herein, the term “active site” and its grammatical equivalents means and includes a region of a catalyst (e.g., atoms, crystal faces, defects etc.) where reactants in the chemical conversion process bond and undergo a chemical reaction to produce desired products. For example, the active site may be a planar exposed metal surface, a crystal edge with imperfect metal valence, or a combination thereof. Thus, most of the volume and most of the surface of the catalyst may be catalytically inactive.

The illustrations presented herein are not meant to be actual views of any particular material, method, or component thereof, but are merely idealized representations, which are employed to describe example embodiments of the present disclosure. The figures are not necessarily drawn to scale. Additionally, elements common between figures may retain the same numerical designation.

Embodiments of the disclosure include a catalyst structure that has the ability to maintain the activity of catalytic active sites, both chemically and physically, when undesired chemical species accumulate on the surface of the catalyst. The catalyst structure includes a transition metal carbide, a transition metal oxide, or a mixed metal oxide as the catalytic material, and a metal material, such as an elemental metal, a metal alloy, or other metal compound, as the metal material (e.g., the carbon collecting component). The catalyst structure may include Pt and Mo₂C, and may be used in many different chemical conversion processes, such as methane dehydroaromatization, methane selective oxidation, hydrocarbon dehydrogenation, carbon monoxide (CO) disproportionation, CO oxidation, CO methanation, Fischer-Tropsch synthesis, and the water-gas shift reaction. In these reactions, carbonaceous species are produced, and the accumulation of carbonaceous species at the active site of the catalyst structure frequently causes catalyst deactivation. The catalyst deactivation may be mitigated with the addition of the metal material (e.g., the carbon collecting component, the mitigation component) such as Pt to the main catalyst (e.g., Mo₂C). The metal material may function as a so-called “carbon collector,” in that the metal material enables the formation of carbon materials, such as carbon nanotubes, carbon filaments, carbon whiskers, etc., with a direction of carbon growth away from the surface of the catalyst. For example, the carbon collecting component may preferentially collect carbon species that are able to diffuse across the surface of the bulk catalyst while the carbon collecting domain remains bound (e.g., anchored) to the catalyst surface. To mitigate catalyst deactivation, the catalyst structure may have an active site on the surface of the catalyst structure, a low energy barrier for carbon diffusion across the surface of the catalyst structure, and the carbon collecting component that preferentially collects carbon with a direction of carbon growth away from the surface. As a result, catalyst deactivation due to accumulation of chemical species on the catalyst surface may be mitigated. Consequently, the performance of catalytic processes may be improved.

The catalyst structures and methods of utilizing them to mitigate catalyst deactivation in accordance with the disclosure are advantageous over conventional catalysts because they prevent the accumulation of undesired chemical species on the active site of the catalyst, leading to longer performance lifetimes of the catalyst structures and more profitable chemical conversion processes. Further, conventional catalyst research has focused on designing active sites that exhibit high selectivity; however, high selectivity often comes at the expense of high activity. Using the catalyst structures in accordance with embodiments of the disclosure, catalyst structures exhibiting high activity may be formed that would otherwise quickly deactivate if formed in accordance with conventional methods. Thus, the catalyst structures and methods of utilizing them in accordance with embodiments of the disclosure may lead to more efficient and economical processes for the production of chemicals such as methanol, benzene, ethylene, propylene, and the like.

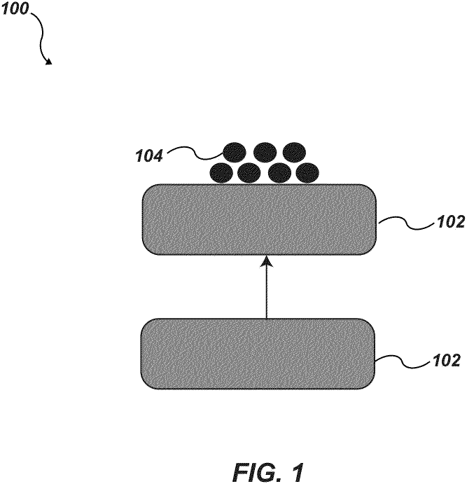

Embodiments of the disclosure will now be described with respect to FIG. 1, which schematically illustrates the fabrication of a catalyst structure 100 in accordance with embodiments of the disclosure. The catalytic material 102 is provided and may include a transition metal carbide, a transition metal oxide, or a mixed metal oxide. For example, the catalytic material 102 may include molybdenum carbide (Mo₂C), titanium carbide (TiC), vanadium carbide (VC), zirconium carbide (ZrC), hafnium carbide (HfC), niobium carbide (NbC, Nb₂C), tantalum carbide (TaCₓ (where x = about 0.4 to about 1)), an oxide of one of the previously-mentioned metals, a mixed metal oxide, or a combination thereof. The metal material (e.g., the carbon collecting component) 104 may be provided (e.g., deposited) on the catalytic material 102. The metal material 104 may be deposited through chemical vapor deposition, atomic layer deposition, chemical bath deposition, electroplating, electroless deposition, spray pyrolysis, physical vapor deposition, molecular beam epitaxy, sputtering, or any other thin film deposition techniques known in the art.

The metal material (e.g., the carbon collecting component) 104 may comprise any carbon collecting material. For example, the metal material 104 may include an elemental metal, a mixed metal (e.g., bimetallic) compound (e.g., an alloy), such as platinum (Pt), iron (Fe), cobalt (Co), nickel (Ni), molybdenum (Mo), copper (Cu), potassium (K), palladium (Pd), rhodium (Rh), ruthenium (Ru), iridium (Ir), or a combination thereof. The metal material 104 is formulated to prevent catalyst deactivation of the catalytic material 102. The metal material 104 (e.g., the carbon collecting component) may preferentially collect carbon species that are able to diffuse across the surface of the bulk catalyst. Further, the metal material 104 may be of nanoparticle size. For example, the metal material 104 may have a mean particle size within a range of from about 100 angstroms to about 100 microns, and more particularly from about 0.1 nanometers to about 100 nanometers (e.g., from about 1.5 nanometers to about 3 nanometers). Additionally, the size of the metal material 104 may be selected to enable the formation of specific carbonaceous structures (e.g., carbon nanotubes, carbon filaments, carbon whiskers, etc.) that grow in a direction away from the surface of the catalyst (e.g., perpendicular to the surface of the catalyst), and leave the metal material 104 anchored to the catalyst surface. By way of non-limiting example, the metal material 104 may include Pt particles exhibiting a mean particle size in a range of about 0.2 nm to about 2.7 nm that are provided on (e.g., deposited on) the catalytic material 102 (e.g., Mo₂C) in loading amounts ranging from about 1.07 wt% to about 4.4 wt%, and that exhibit a dispersion within a range from about 41% to about 57%. The catalyst structure 100 comprises the metal material 104 on (e.g., deposited on) the catalytic material 102. In some embodiments, the catalyst structure 100 includes Pt and Mo₂C, and may be used in many different chemical conversion processes such as methane dehydroaromatization, methane selective oxidation, hydrocarbon dehydrogenation, CO disproportionation, CO oxidation, CO methanation, Fischer-Tropsch synthesis, the water-gas shift reaction, and similar processes.

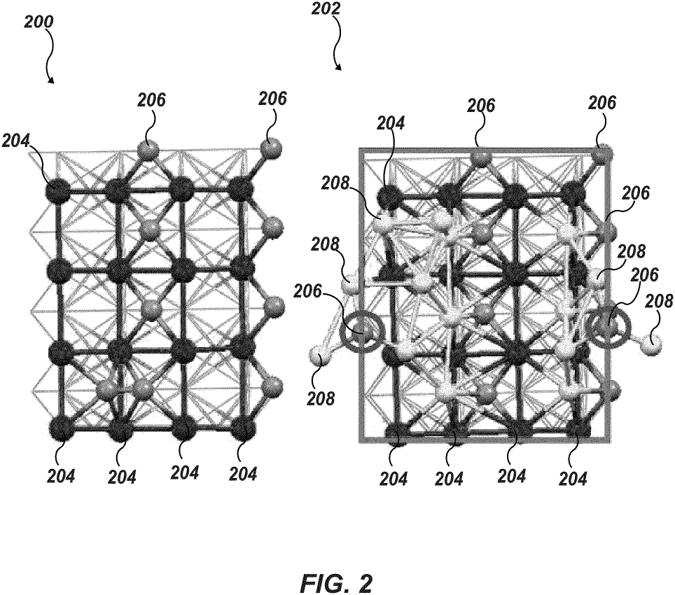

Referring now to FIG. 2, a schematic illustrating the operation of a catalyst configured to mitigate catalyst deactivation is shown. A catalyst structure 200 comprising a catalytic material 204 (e.g., a transition metal carbide, a transition metal oxide, a mixed metal oxide) is shown, as is a catalyst structure 202 comprising the catalytic material 204 and a metal material (e.g., a carbon collecting component, a mitigation component) 208. The catalyst structure 200 comprising the transition metal carbide or transition metal oxide may include Mo₂C, as shown by reference numeral 204. As shown in the catalyst structure 200, an undesired chemical species 206 (e.g., carbon) may accumulate on the catalytic material 204 (e.g., Mo₂C, TiC, VC, ZrC, HfC, NbC, Nb₂C, TaC, similar oxides, mixed metal oxides) during a chemical conversion process. This accumulation may be due to the adsorption (e.g., chemisorption, physisorption) of the undesired chemical species 206 on or near the active sites of the catalytic material 204 during the chemical conversion process. As a result, the number of active sites on the catalytic material 204 may be reduced, or the reaction mechanism and kinetics may change, decreasing the efficiency of the chemical conversion reaction. Further, the accumulation of the undesired chemical species 206 on the catalytic material 204 may deactivate the catalyst altogether, meaning that substantially all of the active sites of the catalytic material 204 may be physically blocked or chemically changed by the undesired chemical species 206, leaving few, if any, active sites available for the reaction of interest. Consequently, the deposition of undesired chemical species 206 on the catalytic surface can lead to diminished reaction rates and a diminished catalytic performance.

This catalyst deactivation may be mitigated through addition of the metal material 208 (e.g., a carbon collecting component, a mitigation component), as shown in catalyst structure 202. The metal material 208 may comprise any carbon collecting material (e.g., Pt, Fe, Co, Ni, Mo, K, Pd, Rh, Ru, Ir, Cu, or combinations thereof) that is provided on (e.g., deposited on, bonded with) the catalytic material 204. The metal material 208 may be added to the catalyst structure 202 through any of the deposition methods described above with respect to FIG. 1. For example, the metal material 208 may be bonded to the catalytic material 204 through a combination of ionic and covalent bonding (e.g., polar covalent bonds). In contrast to the catalyst structure 200 comprising only the catalytic material 204, the catalyst structure 202 comprising the catalytic material 204 and the metal material 208 mitigates catalyst deactivation because the metal material 208 preferentially collects (e.g., preferentially bonds to) the undesired chemical species 206. As a non-limiting example, the bonds between the metal material 208 and the undesired chemical species 206 may include both covalent bonds and ionic bonds. As a result, the metal material 208 may serve to collect the undesired chemical species 206, leaving the catalytic material 204 available to be used in the reaction of interest. Consequently, catalyst deactivation may be prevented, leading to longer catalyst lifetimes and more profitable chemical conversion processes. The process of mitigating catalyst deactivation may be summarized by the following reactions, where M represents an active site on the catalyst structure 202 and Pt represents a metal material 208 (e.g., a carbon collecting component, a mitigation component) deposited on the catalyst structure:

| | |
|---|---|
| 1. 2(M + CO ➔ MCO) | Adsorption (e.g., physisorption) |
| 2. MCO + M ➔ MC + MO | Disproportionation and partial deactivation of an active site |
| 3. MCO + MO ➔ 2M + CO₂ | CO₂ formation |
| 4. MC + Pt ➔ M + PtC | Carbon collection on Pt and regeneration of active site |

Reactions 1, 2, and 3 may proceed solely on the active sites of the catalytic material 204 (e.g., Mo₂C). This process may lead to the deactivation of a main active site (e.g., Mo site on Mo₂C) due to the deposition of carbon (C) atoms. The addition of the metal material (e.g., carbon collecting component, mitigation component) site (e.g., Pt site) in Reaction 4 enables a complete catalytic cycle to take place, where the main active site M is regenerated by the relocation of the undesired chemical species 206 (e.g., C) to the carbon collecting component (e.g., Pt).

As a non-limiting example, the reaction of interest may include methane dehydroaromatization, methane selective oxidation, hydrocarbon dehydrogenation, CO disproportionation, CO oxidation, CO methanation, Fischer-Tropsch synthesis, and the water-gas shift reaction. Additionally, the catalyst comprising the catalyst structure 202 may be used in many chemical conversions, such as the conversion of syngas (CO + H₂) to hydrocarbons, methanol to olefins, methane to ethylene, methane to benzene, propane to propylene and propane to acrylic acid, as well as any other reactions involving carbon-based feedstocks and/or heterogeneous catalytic processes. Furthermore, the catalyst structure 202 is not limited to the catalyst structure shown in FIG. 2, which is presented only as an example. Rather, the catalyst structure comprising the catalytic material 204 and the metal material 208 (e.g., the catalyst structure described with respect to FIG. 1) may exhibit any catalyst structure having active sites on the surface of the catalyst (e.g., on atoms, crystal faces, defects, etc.). For example, the active sites may comprise planar exposed metal surfaces, any crystal edge with imperfect metal valence, or a combination thereof. For example, the active site of the catalytic material may be a molybdenum site.

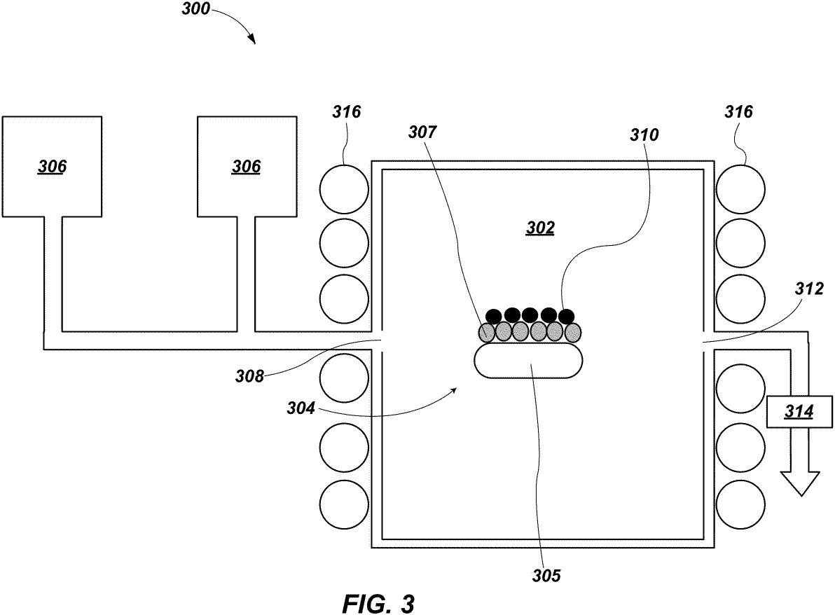

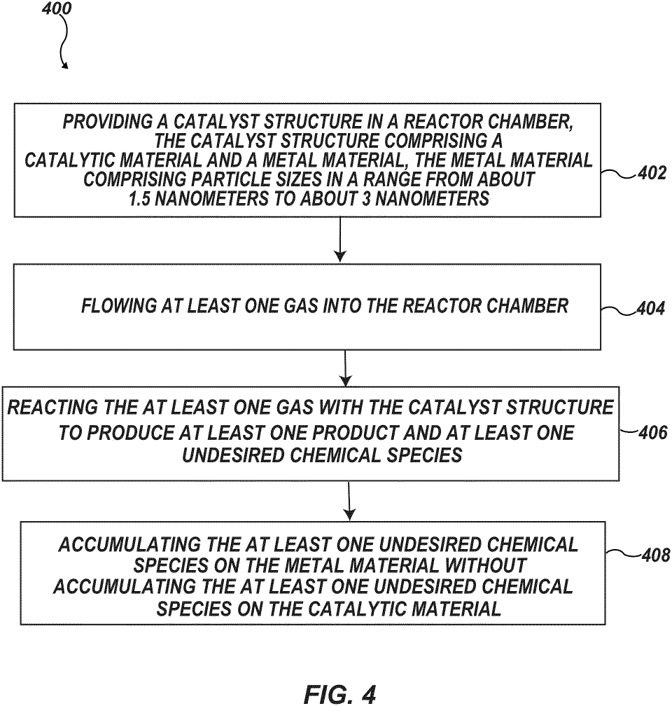

FIG. 3 is a schematic diagram illustrating a method of mitigating catalyst deactivation 300 in accordance with embodiments of the disclosure, and FIG. 4 is a flow chart illustrating a method of mitigating catalyst deactivation 400 in accordance with embodiments of the disclosure.

Referring to FIGS. 3 and 4, the method 400 may include providing a catalyst structure 304 in a reactor chamber 302, as shown in act 402. The catalyst structure may aid in a chemical conversion process. The catalyst structure 304 may include a catalytic material 305 (e.g., Mo₂C, TiC, VC, ZrC, HfC, NbC, Nb₂C, TaC, a transition metal oxide, a similar mixed metal oxide) and a metal material 307 (e.g., a carbon collecting component, a mitigation component), including elemental metals such as Pt, Fe, Co, Ni, Mo, K, Pd, Rh, Ru, Ir, Cu, a metal alloy, a metal compound, or a combination thereof. The metal material 307 may be deposited onto the catalytic material 305 by a conventional thin film deposition technique (e.g., atomic layer deposition). The catalyst structure 304 may further comprise any of the embodiments described above with respect to FIGS. 1 and 2.

As shown in act 404, the method 400 may include flowing at least one gas (e.g., two gases) from a gas source 306 through an inlet 308 into the reactor chamber 302. The gas source 306 may include carbon-based feedstocks (e.g., CO, CO₂, CH₄), inert gases (e.g., H₂, N₂, He), or a combination thereof. As shown in act 406, the method may further include reacting the gas of the gas source 306 with the catalyst structure 304 in the chemical conversion process, where the chemical reaction produces at least one product and at least one undesired chemical species 310 (e.g., carbon, carbon-containing compounds, etc.). The chemical reaction may include methane dehydroaromatization, methane selective oxidation, hydrocarbon dehydrogenation, CO disproportionation, CO oxidation, CO methanation, Fischer-Tropsch synthesis, the water-gas shift reaction, and similar chemical reactions. The method 400 may include accumulating the undesired chemical species 310 on the metal material 307 (e.g., a carbon collecting component, a mitigation component) without accumulating the undesired chemical species 310 on the catalytic material 305, as shown in act 408. As a result, the catalytic material 305 may remain available to aid in the chemical conversion process. For example, the accumulation of the undesired chemical species 310 on the metal material 307 may leave the active sites of the catalytic material 305 available to be used for the reaction of interest (e.g., CO disproportionation, CO oxidation, etc.).

As previously described with respect to FIG. 2, the catalyst structure 304 may have active sites on its surface where reactants and components of reactants (e.g., methane, carbon monoxide, carbon, oxygen) may preferably bond to (e.g., adsorb to), and may also have a low energy barrier for the diffusion of the undesired chemical species 310 (e.g., carbon) across the surface of the catalyst structure 304. Further, the metal material 307 (e.g., a carbon collecting component, a mitigation component) comprising Pt, for example, may preferentially react with the undesired chemical species 310, meaning that it is more thermodynamically favorable for the undesired chemical species 310 to accumulate on the metal material 307 rather than on the catalytic material 305. Additionally, the low energy barrier may allow the undesired chemical species 310 to migrate across the surface of the catalyst structure 304 and accumulate on the metal material 307. The accumulation of the undesired chemical species 310 may have a direction of growth away from the surface of the catalyst structure 304, and may leave the metal material 307 anchored to (e.g., deposited on) the catalytic material 305. For example, the undesired chemical species 310 may grow perpendicular to or at an angle away from the surface of the catalyst structure 304. Further, a particle size of the metal material 307 may be selected to enable the formation of specific structures of the undesired chemical species 310 (e.g., carbon nanotubes, carbon filaments, carbon whiskers, etc.). As a non-limiting example, Pt particles exhibiting a mean particle size in a range from about 2 nm to about 2.7 nm deposited on Mo₂C support the evolution of layered graphitic structures.

The method 400 may further include oxidizing the undesired chemical species 310 on the metal material 307 (e.g., a carbon collecting component, a mitigation component) while leaving the metal material 307 deposited on the catalytic material 305. This oxidation process may occur either in parallel or in sequence with the main chemical conversion process. The oxidized chemical species (not shown) may be removed from the reactor chamber 302. The desired products produced from the method 400 may include gases (e.g., benzene, propylene, ethylene, methanol, carbon dioxide, hydrogen, water vapor, etc.), which may exit the reactor chamber 302 from an outlet 312.

The method 400 may include utilizing additional process components to aid in the chemical conversion process. For example, the method 400 may further include a pressure control device 314 for controlling a pressure within the reactor chamber 302 during the chemical conversion process. The pressure control device 314 may comprise, for example, a vacuum pump.

The method may also include at least one heating device 316 for controlling a temperature within the reactor chamber 302 during the chemical conversion process. The heating devices 316 may comprise, for example, a resistive heating coil, although any other heating device, such as a hot plate, suitable for controlling the temperature of the matter within the reactor chamber 302 may be employed.

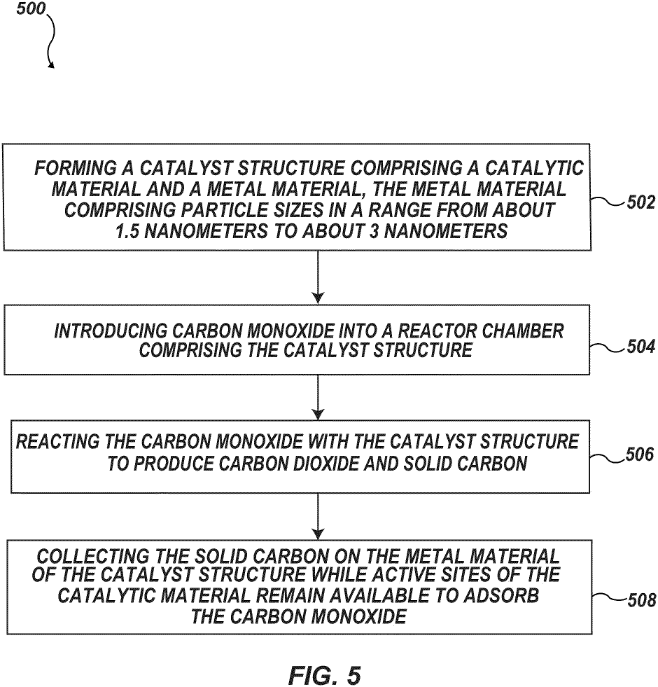

Referring now to FIG. 5, a flow chart illustrating a method of carbon monoxide (CO) disproportionation 500 in accordance with embodiments of the disclosure is shown. The schematic diagram 300 described with respect to FIG. 3 may also be utilized in this method. The method 500 includes forming a catalyst (e.g., catalyst structure 304) comprising a catalytic material (e.g., Mo₂C) and a metal material (e.g., a carbon collecting component, a mitigation component) such as Pt, as shown in act 502. The method 500 further includes introducing (e.g., flowing) carbon monoxide into a reactor chamber (e.g., reactor chamber 302) comprising the catalyst, as shown in act 504, and reacting the carbon monoxide with the catalyst to produce carbon dioxide and solid carbon, as shown in act 506. The method 500 also includes collecting the solid carbon on the metal material (e.g., metal material 307) of the catalyst while active sites of the catalytic material (e.g., catalytic material 305) remain available to adsorb the carbon monoxide, as shown in act 508. The catalytic material may comprise the transition metal carbide (e.g., Mo₂C, TiC, VC, ZrC, HfC, NbC, Nb₂C, TaC), a similar oxide, a mixed metal oxide, or a combination thereof and the metal material may comprise the metal (e.g., Pt, Fe, Co, Ni, Mo, K, Pd, Rh, Ru, Ir, Cu, or a combination thereof). As described previously, the metal material may be formed on (e.g., deposited on) the catalytic material through conventional thin film deposition processes (e.g., atomic layer deposition). The adsorption and accumulation (e.g., collection) of the solid carbon on the metal material may occur in substantially the same way as previously described with respect to FIGS. 1-4. For example, the active sites of the catalytic material may be available to adsorb the oxygen from the carbon monoxide, and the carbon from the carbon monoxide may diffuse across a surface of the catalyst and accumulate on the metal material (e.g., carbon collecting component, mitigation component).

The embodiments of the disclosure, such as the catalysts and methods of using them described with respect to FIGS. 1-5, may also be utilized in any chemical conversion processes where carbon oxides or hydrocarbons are used as feedstocks. For example, the embodiments of the disclosure may be utilized in reactions such as selective oxidation, partial oxidation, and dehydrogenation reactions, as well as any other reactions where undesired carbon accumulation occurs.

The following examples serve to further illustrate embodiments of the disclosure in more detail. These examples are not to be construed as being exhaustive or exclusive as to the scope of this disclosure.

### EXAMPLES

### Example 1

### Catalyst Structure Fabrication

Catalyst structures were fabricated in accordance with embodiments of the disclosure. The catalytic material was Mo₂C and the metal material (e.g., carbon collecting component) was Pt, where the Pt had an average particle size in the nanometer range, such as in a range from about 1 nm to about 5 nm (e.g., about 2 nm to about 2.5 nm).

The catalyst structures were prepared in accordance with embodiments of the disclosure and included the ingredients shown in Table 1. The catalytic material was Mo₂C and the metal material was Pt. Samples utilized in the tests described in Example 2 were formed from the exemplary formulations described in Table 1 below.

TABLE 1

Catalyst Structure Formulations

| Formulation | Reference Name | Metal Material (Pt) (wt%) |
|---|---|---|
| A | Mo₂C | 0 |
| B | 50Pt/Mo₂C | 1.07 |
| C | 100Pt/Mo2C | 4.4 |

The Pt/Mo₂C samples were prepared with 50 and 100 atomic layer deposition (ALD) cycles, and are denoted herein as 50 Pt/Mo₂C and 100 Pt/Mo₂C, which included about 1.07 wt% Pt and about 4.4 wt% Pt respectively. The material was ex situ pretreated by flowing a gas mixture of about 15% CH₄ in H₂ at a flow rate of about 150 mL/min and a temperature of about 590° C. for about 4 hours to reduce the Mo₂C surface that may have been oxidized in air.

### Example 2

### Catalyst Structure Testing and Analysis

The CO disproportionation reaction (2CO ↔ CO₂ + C) was investigated with the catalysts of Example 1. It was found that the catalytic material, Mo₂C, quickly deactivated due to carbon accumulation, while Mo₂C materials containing the metal material (e.g., carbon collecting component, mitigation component) Pt, were more tolerant to deactivation. Transient kinetic tests were performed on catalyst structures prepared in accordance with the disclosure, such as those listed in Table 1.

Temporal analysis of products (TAP) kinetic experiments were performed. Before beginning the TAP experiments, the catalyst was heated in the TAP reactor, under vacuum, from room temperature to about 400° C., to desorb any surface species. Minor CO₂ release was observed, which may be attributed to the surface oxygen formed during the ambient transfer and the surface carbon either from uncoordinated C in Mo₂C or from CH₄ decomposition in the reduction process. In addition, the CO₂ fraction yield from converted CO was always less than 50% during temperature programmed pulsing experiments. The production of 1 mol CO₂ via CO oxidation by the surface oxygen uses 1 mol of CO. Thus, the contribution of the ambient oxidation to CO₂ production was insignificant and the CO₂ produced in the temperature programmed pulsing experiment occurred predominantly through the disproportionation process. The experimental temperature was linearly increased at a much slower rate (about 1° C./min) from room temperature to about 300° C. while pulsing CO. The exit flow pulse responses of unreacted CO and the CO₂ produced on the Mo₂C, 50 Pt/Mo₂C and 100 Pt/Mo₂C catalysts were recorded in the temperature-programmed pulsing experiments. The morphology of Pt/Mo₂C samples after TAP experiments were measured by TEM on a JEM-2100P electron microscope operating at 200 kV (JEOL Ltd., Tokyo, Japan).

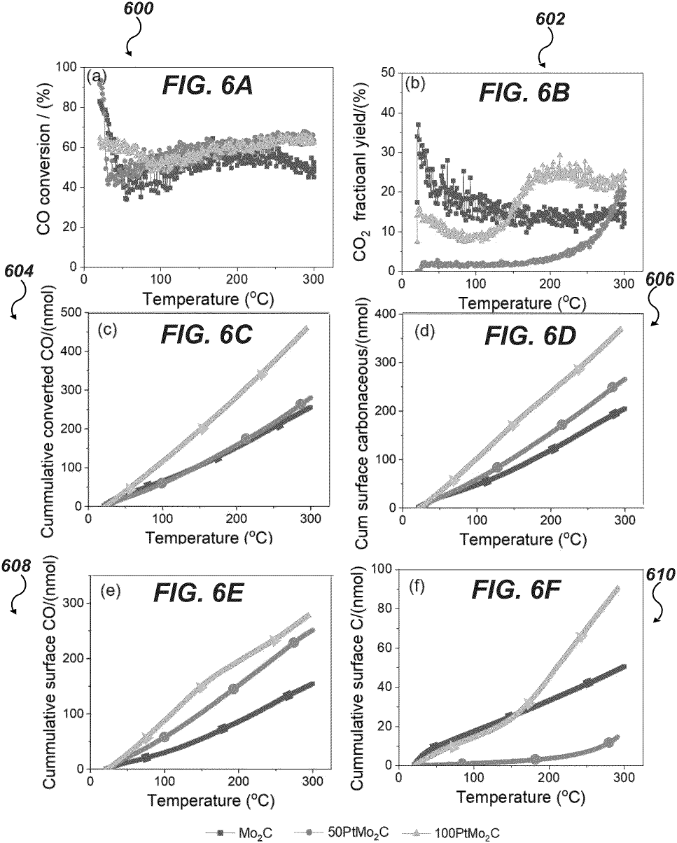

FIGS. 6A-6F show the results of the temperature programmed experiments with the continuous pulsing of CO on the clean surfaces of Mo₂C, 50 Pt/Mo₂C and 100 Pt/Mo₂C. FIG. 6A shows the CO conversion of the catalysts as a function of temperature, FIG. 6B shows the CO₂ fractional yield of the catalysts as a function of temperature, FIG. 6C shows the cumulative surface CO on the catalysts as a function of temperature, FIG. 6D shows the cumulative surface C as a function of temperature during CO pulsing over the Mo₂C and Pt/Mo₂C catalysts while heating up to 300° C. at 1° C. per minute, FIG. 6E shows the cumulative surface CO on the catalysts, and FIG. 6F shows the cumulative surface carbon (from a Boudouard process) during CO pulsing over the Mo₂C and Pt/Mo₂C catalysts while heating up to 300° C. at 1° C. per minute. Throughout the experiment, significant CO₂ production was observed on the Mo₂C support at low temperatures (e.g., less than about 100° C.). The Pt-modified catalysts also showed low-temperature CO₂ production, but the intensity was significantly lower.

The CO conversion and fractional CO₂ yield during CO pulsing over the three samples are shown in graph 600 and graph 602, respectively, of FIGS. 6A-6B. The fractional CO₂ yield is defined as the fraction of the adsorbed CO molecules that are transformed into CO₂. A basic evaluation of this data indicates that while the conversion of CO was generally the same for these materials, the presence of Pt resulted in remarkably distinct production trends for CO₂. For all catalysts, the per-pulse CO conversion was very high (e.g., greater than about 40%) throughout the experiment, especially for the pure Mo₂C support and the 50 Pt/Mo₂C catalyst at low temperatures (e.g., less than about 50° C.).

On a pure Mo₂C surface, a simultaneous decrease in CO conversion and CO₂ production was observed at low temperatures (e.g., below about 50° C.). Without being bound by any theory, it is believed that CO conversion decreased as more active sites were occupied. Surface oxygen was then consumed, slowing the production of CO₂. However, as the temperature increased, the declining conversion of CO exhibited different behavior near about 50° C. For example, the temperature dependence of both CO and CO₂ exhibited an apparent plateau, and near about 225° C., CO conversion began to decrease.

With respect to 50 Pt/Mo₂C, the CO conversion trend was substantially the same as that of Mo₂C below about 200° C., as shown in graph 604 of FIG. 6C. This suggested that the same Mo active sites were used for CO conversion, and that the small Pt domains (e.g., Pt domains having an average particle size in a range from about 2 nanometers to about 2.7 nanometers) did not directly contribute to low-temperature CO conversion. The production of CO₂, however, was not observed below about 200° C. as it was for Mo₂C, indicating that Pt participated in the accumulation and storage of CO. At about 250° C., the CO conversion on Mo₂C began to decrease, but that of the Pt samples continued increasing with temperature, indicating that the Pt catalyst assisted in maintaining CO conversion sites on Mo₂C by collecting carbon. The Pt domain size on the 50 Pt/Mo₂C and 100 Pt/Mo₂C was approximately 2 nm and approximately 2.7 nm, respectively.

Compared to the reactions on the pure Mo₂C and 50 Pt/Mo₂C catalyst surfaces, the total conversion of CO was lower and the rate of deactivation was slower on the 100 Pt/Mo₂C surface at low temperatures (e.g., less than about 100° C.), as shown in graphs 604 and 606. Without being bound by any theory, it is believed that CO may have adsorbed reversibly on the Pt (111) sites (not detected on the smaller 50 Pt/Mo₂C domains) in addition to the Mo sites. The reversible adsorption may have decreased the low-temperature CO conversion. In the low-temperature region, however, CO₂ production was observed with the exception of the 50 Pt/Mo₂C sample, suggesting that the 100 Pt/Mo₂C sample may have sites that disproportionate CO at lower temperatures. This process declined with temperature, similar to the process seen with the Mo₂C catalyst. The transition point where CO conversion began increasing occurred at a higher temperature (e.g., about 100° C.). Above about 100° C., CO conversion was essentially the same for all three materials. However, CO₂ production for the 100 Pt/Mo₂C sample demonstrated a dramatic acceleration. Its acceleration was shifted to lower temperatures, in contrast with that of 50 Pt/Mo₂C.

Graphs 608 and 610 of FIGS. 6E-6F show the CO and C accumulation on the surface of the catalyst structures, respectively, as a function of temperature. The cumulative surface CO and C were balanced from CO conversion as well as from the production of CO₂. The carbon accumulation was calculated from the CO₂ production data according to Boudouard chemistry. The CO surface accumulation was calculated as the difference between the total converted CO and the cumulative surface C as well as the total CO₂ produced. If all of the CO present in the reaction underwent the Boudouard reaction, then a constant CO₂ fractional yield of 0.5 would be expected, according to the Boudouard reaction stoichiometry. However, the fractional yield was lower, indicating an additional pathway for CO storage. Thus, the data indicated that there are other pathways, (e.g., physisorption or chemisorption on surface), in addition to the disproportionation reaction, to store CO.

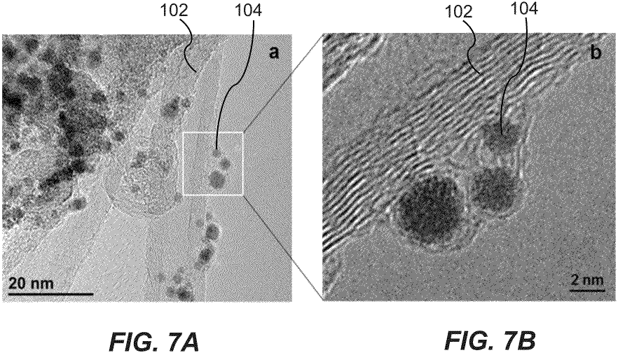

The catalyst structures were retrieved following the TAP experiments and subjected to transmission electron microscopy (TEM) characterization in order to investigate potential structural changes and deposition of carbon species during the TAP experiments. The TEM micrographs are shown in FIGS. 7A-7B, with FIG. 7B being an enlargement of the boxed portion of FIG. 7A. As shown in FIGS. 7A-7B, the representative TEM results on the 100 Pt/Mo₂C catalysts showed considerable carbon formation on the surface of the catalytic material 102, where the carbon formed multi-wall nanosheets or onion-like structures. The Pt nanoparticles on the catalytic material 102 were encapsulated by multi-layers of carbon species. Those species were likely graphene sheets and/or multi-wall carbon nanotubes, based on the interlayer spacing.

Analysis of the transient kinetic data for these materials resulted in a kinetic model where Mo was the active site for CO disproportionation and Pt acted as a carbon collector (e.g., as a trapping agent). Structural analysis validated that carbon nanotube structures formed exclusively on the Pt particles.

### Example 3

### Density Functional Theory Investigation

To understand the nature of active sites as well as the role of the deposited Pt nanoparticles in carbon collection, density functional theory (DFT) was used to calculate the potential energy surfaces of the Boudouard reaction on the pure Mo₂C (100), Pt (111) surfaces and the Pt/Mo₂C interface. The results with the Perdew-Burke-Ernzerhof (PBE) exchange-correlation functional were benchmarked with the M06L functional as the latter includes dispersion effects in its parameterization and correctly describes the CO adsorption on Pt (111) surface.

The Boudouard reaction on a Pt (111) (4×4) surface for the addition of two CO molecules and the coverage of ⅛ ML showed that the dissociation of CO on Pt (111) (4×4) surface was endothermic by 1.26 eV with the M06L functional. The barrier energy for the dissociation of CO was calculated to be 4.25 eV from the CO adsorbed structure. The formation of CO₂ occurred by surface O diffusion to the second CO with an energy barrier of 0.73 eV. Although the overall Boudouard reaction process on Pt (111) was exothermic by -1.43 eV, the dissociation step to produce the ‘reactive’ surface O was a 1.26 eV endothermic step with a substantially high barrier energy of 4.25 eV. Thus, the Boudouard reaction did not occur readily on Pt (111) surface.

In contrast with CO dissociation on Pt (111), CO dissociation on Mo₂C (100) was an exothermic process by -4.36 eV. The most favorable site for C was the site with C bonded to two lower Mo atoms and one C atom (FIG. 2). The energy barrier for CO dissociation was predicted to be only 0.81 eV and the energy of the transition state structure was still below the reactant asymptotic energy of gas phase CO and pure Mo₂C (100) slab. Thus, under low coverage conditions, CO should readily dissociate on clean β-Mo₂C (100) surface to produce surface O atoms for further oxidation reactions. CO₂ was produced from the surface O generated from the first CO and an adjacent CO with an energy barrier of 1.79 eV. The residual surface C atoms deactivated the Mo sites on pure Mo₂ C.

At the Pt/Mo₂C interface, the dissociation of CO is not likely to occur on the deposited Pt atoms, as this step was endothermic by 1.06 eV. Thus, CO dissociation on the interface, if it occurs, is likely to take place at different sites, potentially on the Mo sites via a preliminary step of CO diffusion from Pt to Mo sites. The CO diffusion barrier from the Pt site to the Mo site was predicted to be 0.88 eV, and most of this was due to the endothermicity of the process. In comparison to the endothermic process on the Pt of the Pt/Mo₂C interface, the CO dissociation step on the Mo sites of the interface was still exothermic by -1.24 eV. The dissociation barrier from the adsorbed species was calculated to be 2.27 eV, which was larger than that on pure β-Mo₂C (100) surface. This suggests that the CO dissociation at the Pt/Mo₂C interface took place at a higher temperature than that at the pure Mo₂C (100) surface.

Similar to the Pt (111) and pure Mo₂C (100) surface, CO₂ was also produced from the surface O from the first CO dissociation and the second CO. The energy barrier was predicted to be 0.63 eV. The overall process to produce CO₂ from two CO molecules was still an exothermic reaction on the interface. Again, it was less exothermic than that on the pure Mo₂C (100) surface.

After the release of CO₂, the surface C atom bonded to the bridge site of upper Mo atoms was likely to diffuse to the Pt region on the interface (FIG. 2), as the structure with C adsorption on a Pt hollow site was more stable than that with C adsorption on a bridge Mo site. The migration barrier was calculated to be 0.90 eV.

The adsorption energies of C on Mo₂C (100) surface and Pt/Mo₂C interface were helpful in understanding the collection of surface C atoms. The C adsorption energies on different sites followed the order of C*-Mo₂C > Pt*-Pt/Mo₂C > Mo*-Pt/Mo₂C > Mo*-Mo₂C. Although the formation of a C—C bond was most favorable for C adsorption, the most favorable sites at the interface were most likely occupied by the deposited Pt atoms, as Pt atoms preferred the formation of Pt—C bonds instead of Pt—Mo bonds. Thus, at the Pt/Mo₂C interface, the accumulated C atoms from the Boudouard reaction produced on the Mo sites most likely diffuse to the Pt region or surface C area if the active sites are not occupied by Pt atoms.

Overall, a thermodynamically favorable energy barrier was found for CO dissociation on a Mo site of the Mo₂C (100) crystal surface. Additionally, a thermodynamically unfavorable energy barrier for CO dissociation was found on Pt. In contrast, a thermodynamically favorable energy barrier was found for C atom migration to the Pt region. Without being bound by any theory, it is believed that the CO preferentially dissociates on the Mo site, and the accumulated C on the Mo site migrates to the Pt, which acts as a carbon collector to prevent catalyst deactivation.

Although the foregoing descriptions contain many specifics, these are not to be construed as limiting the scope of the disclosure, but merely as providing certain exemplary embodiments. Similarly, other embodiments of the disclosure may be devised that do not depart from the scope of the disclosure. For example, features described herein with reference to one embodiment may also be provided in others of the embodiments described herein. The scope of the embodiments of the disclosure is, therefore, indicated and limited only by the appended claims and their legal equivalents, rather than by the foregoing description. All additions, deletions, and modifications to the disclosure, as disclosed herein, which fall within the meaning and scope of the claims, are encompassed by the disclosure.

1. A method of mitigating catalyst deactivation, comprising:
providing a catalyst structure in a reactor chamber, the catalyst structure comprising a catalytic material and a metal material, the metal material comprising particle sizes in a range from about 1.5 nanometers to about 3 nanometers;
flowing at least one gas into the reactor chamber;
reacting the at least one gas with the catalyst structure to produce at least one product and at least one undesired chemical species; and
accumulating the at least one undesired chemical species on the metal material without accumulating the at least one undesired chemical species on the catalytic material.

2. The method of claim 1, wherein reacting the at least one gas with the catalyst structure to produce at least one product and at least one undesired chemical species comprises reacting the at least one gas with the catalyst structure to produce at least one carbon-containing compound.

3. The method of claim 1, wherein reacting the at least one gas with the catalyst structure to produce at least one product and at least one undesired chemical species comprises producing one or more of carbon nanofibers, carbon nanotubes, carbon filaments, or carbon whiskers.

4. The method of claim 1, further comprising oxidizing the at least one undesired chemical species on the metal material while the metal material remains on the catalytic material.

5. The method of claim 4, wherein oxidizing the at least one undesired chemical species comprises oxidizing the at least one undesired chemical species in parallel with reacting the at least one gas with the catalyst structure.

6. The method of claim 4, wherein oxidizing the at least one undesired chemical species comprises oxidizing the at least one undesired chemical species in sequence with reacting the at least one gas with the catalyst structure.

7. The method of claim 4, further comprising removing the oxidized at least one undesired chemical species from the reactor chamber.

8. The method of claim 1, wherein reacting the at least one gas with the catalyst structure to produce at least one product and at least one undesired chemical species comprises producing at least one of benzene, propylene, ethylene, methanol, carbon dioxide, hydrogen, or water vapor.

9. The method of claim 1, wherein accumulating the at least one undesired chemical species on the metal material without accumulating the at least one undesired chemical species on the catalytic material comprises bonding the at least one undesired chemical species to the metal material.

10. A method of mitigating catalyst deactivation, comprising:
flowing at least one gas into a reactor chamber comprising a catalyst structure, the catalyst structure comprising a catalytic material and a carbon collecting material on the catalytic material, the carbon collecting material comprising particle sizes in a range from about 1.5 nanometers to about 3 nanometers;
reacting the at least one gas with the catalyst structure to produce at least one gaseous product and at least one carbon species formulated to diffuse across the catalyst structure,
adsorbing the at least one carbon species to the carbon collecting material without substantially adsorbing the at least one carbon species to the catalytic material; and
removing the at least one carbon species from the carbon collecting material while the carbon collecting material remains on the catalytic material.

11. The method of claim 10, wherein flowing at least one gas into a reactor chamber comprising a catalyst structure comprises flowing carbon monoxide, carbon dioxide, methane, hydrogen, nitrogen, helium, or a combination thereof into the reactor chamber.

12. The method of claim 10, wherein adsorbing the at least one carbon species to the carbon collecting material comprises growing the at least one carbon species perpendicular to a surface of the catalyst structure.

13. The method of claim 10, wherein adsorbing the at least one carbon species to the carbon collecting material without substantially adsorbing the at least one carbon species to the catalytic material comprises adsorbing solid carbon to the carbon collecting material while active sites of the catalytic material are substantially free of solid carbon.

14. The method of claim 10, wherein adsorbing the at least one carbon species to the carbon collecting material without substantially adsorbing the at least one carbon species to the catalytic material comprises forming the at least one carbon species perpendicular to a surface of the catalytic material.

15. A method of mitigating catalyst deactivation, comprising:
flowing at least one carbon-containing gas into a reactor chamber comprising a catalyst structure, the catalyst structure comprising:
a catalytic material comprising a transition metal carbide material, a transition metal oxide material, or a mixed metal oxide material; and
a carbon collecting material on the catalytic material, the carbon collecting material comprising particle sizes in a range from about 1.5 nanometers to about 3 nanometers;
reacting the at least one carbon-containing gas with the catalyst structure to produce at least one gaseous product and at least one carbon species;
diffusing the at least one carbon species through the catalyst structure;
bonding the at least one carbon species to the carbon collecting material without substantially bonding the at least one carbon species to the catalytic material; and
removing the at least one carbon species from the carbon collecting material while the carbon collecting material remains bonded to the catalytic material.

16. The method of claim 15, wherein flowing at least one carbon-containing gas into a reactor chamber comprises flowing a carbon oxide gas or a hydrocarbon gas into the reactor chamber.

17. The method of claim 15, wherein reacting the at least one carbon-containing gas with the catalyst structure to produce at least one carbon material and at least one carbon species comprises reacting the at least one carbon-containing gas with a planar exposed metal surface of the catalytic material, a crystal edge with imperfect metal valence of the catalytic material, or a combination thereof.

18. The method of claim 15, wherein reacting the at least one carbon-containing gas with the catalyst structure to produce at least one carbon material and at least one carbon species comprises reacting the at least one carbon-containing gas with the catalyst structure comprising molybdenum carbide and platinum.

19. The method of claim 15, wherein reacting the at least one carbon-containing gas with the catalyst structure to produce at least one carbon material and at least one carbon species comprises reacting the at least one carbon-containing gas with the catalyst structure to produce carbon dioxide.

20. The method of claim 15, further comprising removing the at least one gaseous product from the reactor chamber.
